(19) United States
(12) Patent Application Publication
(10) Pub. No.: US 2017/0083741 A1
(43) Pub. Date: Mar. 23, 2017

(54) METHOD AND DEVICE FOR GENERATING INSTRUCTION

(71) Applicant: Xiaomi Inc., Beijing (CN)

(72) Inventors: Yuan Gao, Beijing (CN); Gaocai Han, Beijing (CN); Hongzhi Jin, Beijing (CN)

(73) Assignee: Xiaomi Inc., Beijing (CN)

(21) Appl. No.: 15/259,771

(22) Filed: Sep. 8, 2016

(30) Foreign Application Priority Data
Sep. 22, 2015 (CN) 201510609574.3

(51) Int. Cl. G06K 9/00; G06K 9/62; G06K 9/52; G06T 7/00

(52) U.S. Cl. CPC G06K 9/00013; G06T 7/0042; G06K 9/6215; G06K 9/00335; G06K 9/52

(57) ABSTRACT

Methods and devices are disclosed for generating an operational instruction for controlling a function on a mobile device based on attributes identified from images captured from a fingerprint identification module.

### CROSS-REFERENCE TO RELATED APPLICATIONS

This application claims priority to Chinese Patent Application No. 201510609574.3, filed on Sep. 22, 2015, the entire contents of which are hereby incorporated by reference herein.

### TECHNICAL FIELD

The present disclosure generally relates to the field of mobile terminals such as smart phones and tablet computers, and more particularly, to a method and a device for generating an instruction based on input received by a mobile terminal.

### BACKGROUND

Fingerprint sensors have been deployed in mobile terminals such as smart phones and tablet computers.

A fingerprint sensor may detect a user's fingerprint, and determine whether it matches with a known target fingerprint.

### SUMMARY

According to some embodiments, an instruction generation method is provided. The method may include acquiring at least two frames of fingerprint images of the same fingerprint, calculating position change information of the fingerprint according to the at least two frames of fingerprint images, and generating an operational instruction according to the position change information, wherein the operational instruction comprises a translation instruction and/or a rotation instruction.

According to some embodiments, a non-transitory computer-readable storage medium having stored therein instructions that, when executed by a processor of a mobile terminal, causes the mobile terminal to perform the method for generating an instruction. The method may include acquiring at least two frames of fingerprint images of the same fingerprint, calculating position change information of the fingerprint according to the at least two frames of fingerprint images, and generating an operational instruction according to the position change information, wherein the operational instruction comprises a translation instruction and/or a rotation instruction.

According to some embodiments, an instruction generation device is provided. The instruction generation device may include a processor, and a memory configured to store instructions executable by the processor. The processor may be configured to acquire at least two frames of fingerprint images of the same fingerprint, calculate position change information of the fingerprint according to the at least two frames of fingerprint images, and generate an operating instruction according to the position change information, wherein the operating instruction comprises a translation instruction and/or a rotation instruction.

It should be understood that the above general description and detailed description below are exemplary and explanatory and not intended to limit the present disclosure.

### BRIEF DESCRIPTION OF THE DRAWINGS

FIG. 1 illustrates a block diagram of an exemplary mobile terminal.

FIG. 2 illustrates a flow chart of logic implemented by a mobile terminal to implement an instruction generation process.

FIG. 3 illustrates a flow chart of logic implemented by a mobile terminal to implement an instruction generation process.

FIG. 4 illustrates exemplary fingerprint image frames and characteristic area maps.

FIG. 5 illustrates a flow chart of logic implemented by a mobile terminal to implement an instruction generation process.

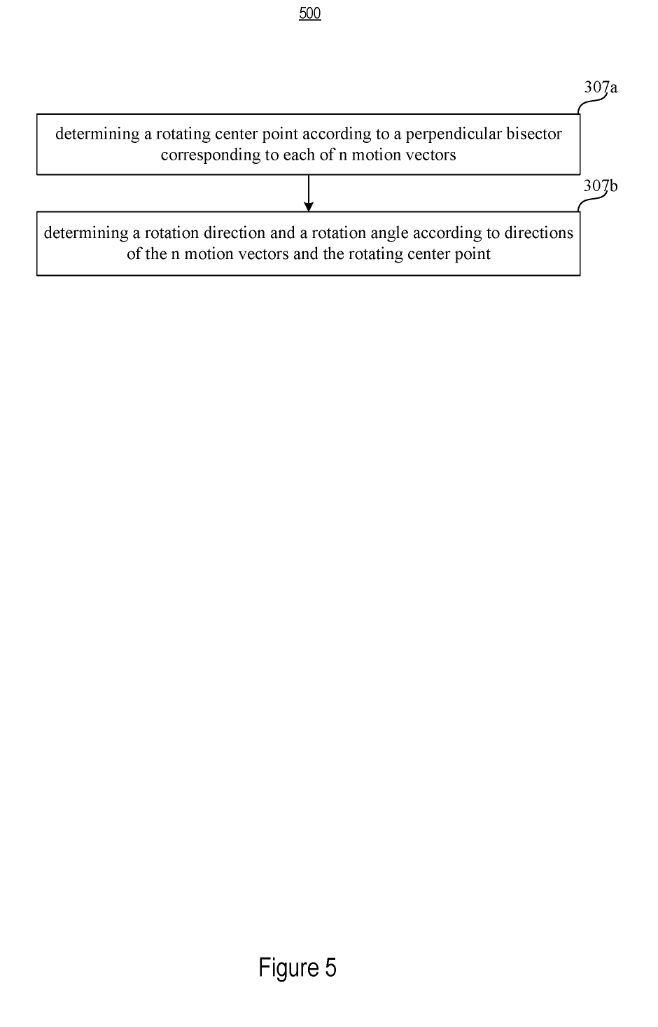

FIG. 6 illustrates exemplary characteristic area maps.

FIG. 7 illustrates a diagram of an exemplary architecture of a device.

FIG. 8 is a block diagram of an exemplary device.

FIG. 9 is a block diagram of an exemplary device.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

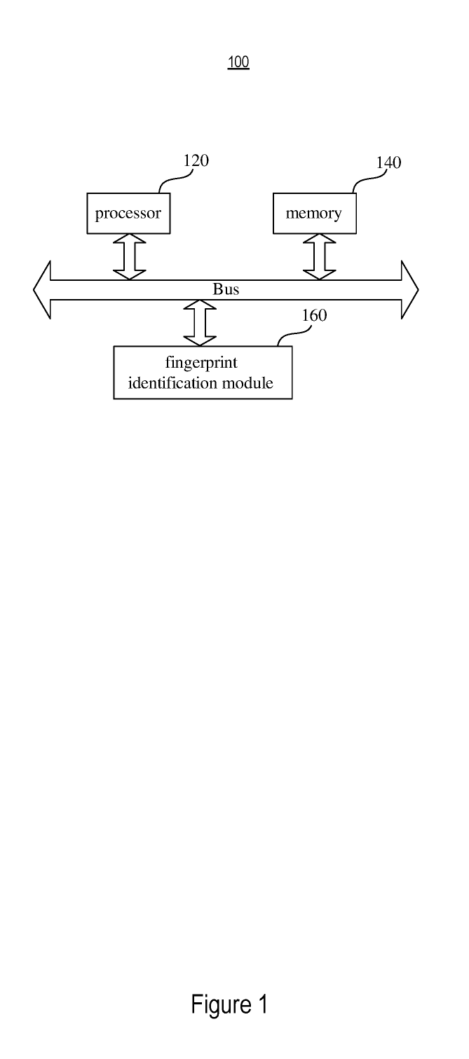

FIG. 1 shows a block diagram illustrating an exemplary mobile terminal 100 according to some embodiments. The mobile terminal 100 may be a communication device that includes well known computing systems, environments, and/or configurations suitable for implementing features described herein such as, for example, smart phones, tablet computers, E-book readers, personal computers (PCs), server computers, handheld or laptop devices, multiprocessor systems, microprocessor-based systems, network PCs, server computers, minicomputers, mainframe computers, embedded systems, distributed computing environments that include any of the above systems or devices, and the like. The mobile terminal 100 includes a processor 120, as well as a memory 140 and fingerprint identification module (FIM) 160, all of which may communicate through a bus.

Executable instructions of the processor 120 are stored in the memory 140. The processor may execute the instructions to control the mobile terminal 100, and in particular the FIM 160 to implement any of the features described herein.

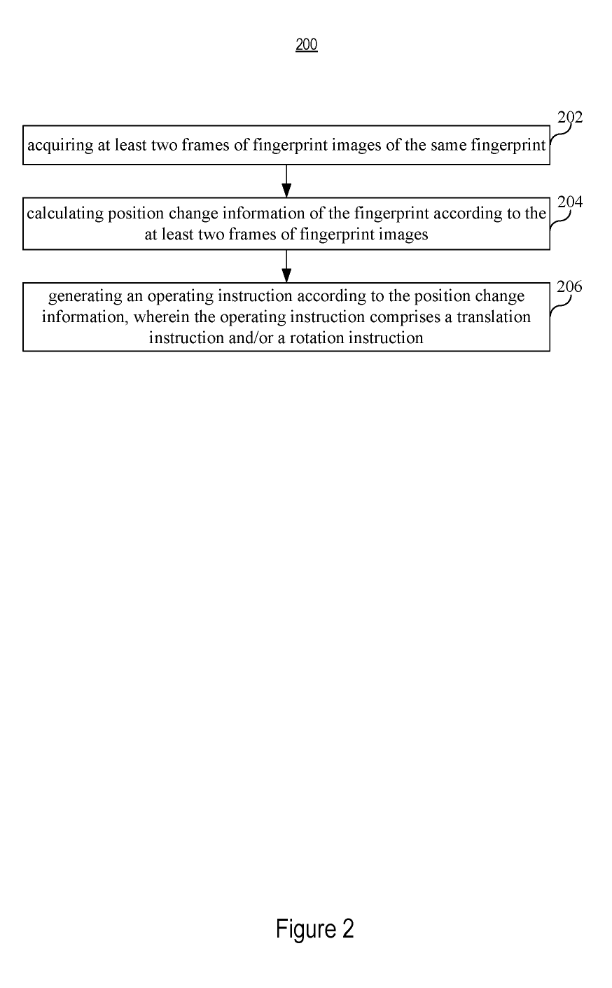

The fingerprint identification module 160 may also be referred to as a fingerprint identification sensor. The fingerprint identification module 160 as described with relation to FIG. 2, and according to other embodiments described herein, may include sensors, image capturing devices, software logic, and/or other circuitry for detecting contact of a user's finger or otherwise detectable object, acquiring an image of the finger or otherwise detectable object, and identifying attributes of the finger or otherwise detectable object. For example, the fingerprint identification module 160 may detect the user's fingerprint, as well as attributes of the detected fingerprint, from images captured by the fingerprint identification module 160. The image capturing device included in the fingerprint identification module 160 may be a light measuring based optical scanner (e.g., a charge coupled device), or an electrical current measuring based capacitive scanner (e.g., using capacitive sensors).

FIG. 2 shows a flow chart 200 of logic that may be implemented by the mobile terminal 100 to obtain an operational instruction based on fingerprint attributes detected by, for example, the fingerprint identification module 160, according to an exemplary embodiment. The process for obtaining the operational instruction described by flow chart 200 may be executed by the fingerprint identification module 160, or processor 120 shown in FIG. 1.

With reference to flow chart 200, at least two frames of fingerprint images may be captured by an image capturing device (202). The fingerprint images may correspond to a same finger. Although reference is made to capturing images of a user's fingerprint, in alternatively embodiments the fingerprint identification module 160 may be configured to capture images of other objects that include identifiable attributes (e.g., stylus pen or other pointer tool), and implement any of the features described herein based on the object images.

As described, the fingerprint identification module 160 may include an image capturing device capable of acquiring a fingerprint image. The fingerprint identification module 160 may be configured to capture an image based on command inputs provided to the corresponding mobile terminal 100. Optionally, when a finger is placed in an identification area of the fingerprint identification module, the fingerprint identification module 160 may acquire the fingerprint images by capturing each fingerprint image according to a predetermined time interval. Each fingerprint frame referenced herein may correspond to a separate captured image.

With reference to flow chart 200, position change information describing the fingerprint moving on the identification area of the fingerprint identification module 160 may be determined according to the at least two frames of fingerprint images captured by the fingerprint identification module 160 (204).

If the finger translates, rotates, or otherwise moves to different positions on the identification area of the fingerprint identification module 160, the fingerprint image of the finger may also change such that two or more fingerprint images (frames) may be captured. The position change information of the fingerprint may be calculated by virtue of the at least two frames of fingerprint images which are sequentially acquired.

With reference to flow chart 200, an operational instruction may be generated according to the position change information (206). The operational instruction may be interpreted by the mobile terminal 100 to implement a translation instruction for moving an object (e.g., pointer object) displayed on a graphical interface of the mobile terminal, a rotation instruction for rotating a selected object (e.g., selected image) displayed on a graphical interface of the mobile terminal 100, or another operational function on the mobile terminal 100. It follows that the fingerprint identification module 160 may be re-purposed on the mobile terminal 100 to be utilized similar to a tracking pad or other navigational tool on the mobile terminal 100.

According to some embodiments, the operational instruction may be referenced by the processor 120 of the mobile terminal 100 to control an operation object. The operation object may be a user interface element displayed on a display screen or hardware of the mobile terminal 100. Other types of operation objects are also contemplated in other embodiments of the present disclosure.

In view of the above, different position information of the same fingerprint may be obtained from two or more fingerprint images. The position information may then be analyzed to obtain the corresponding position change information to generate the corresponding operational instruction, and the operational instruction may be configured to implement an operational function on the corresponding mobile terminal. For example, the operational instruction may implement the operational function to control movement of an operation object displayed on the corresponding mobile terminal. This way, the fingerprint identification module 160 may further be utilized to generate an operational instruction based on a movement of a finger on the identification area, where the operational instruction may be referenced to implement an operational function on the mobile terminal (e.g., a translation operation or a rotation operation on an object).

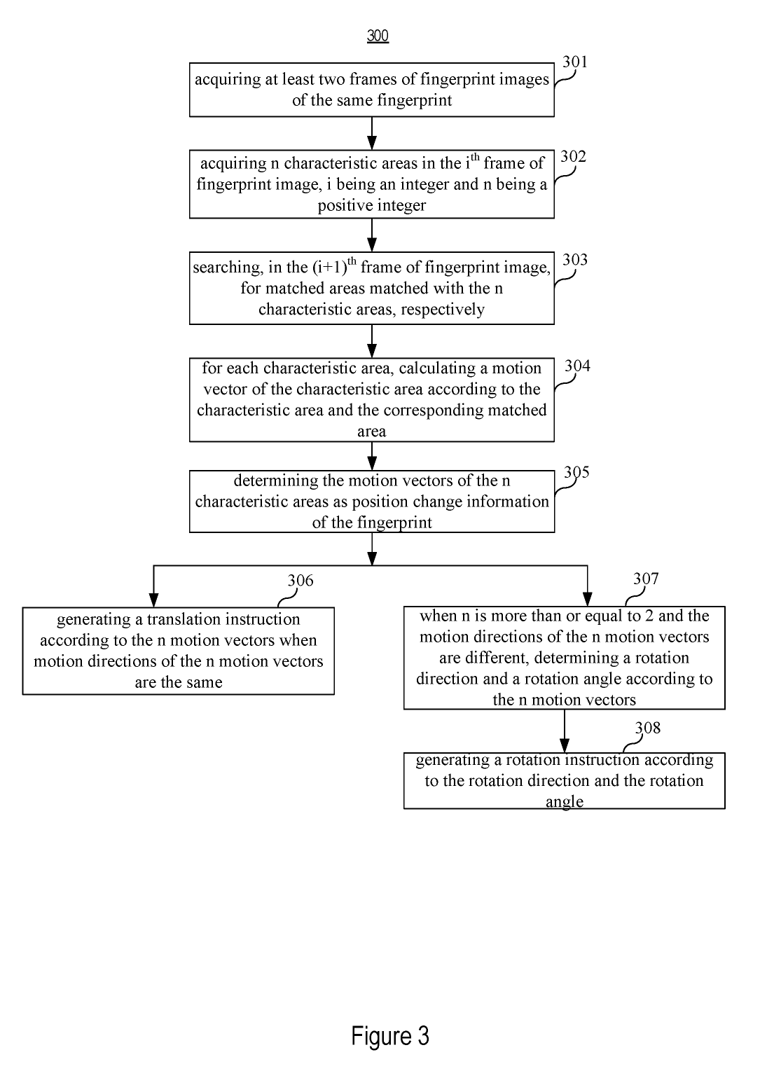

FIG. 3 shows a flow chart 300 of logic that an exemplary mobile terminal may implement according to an instruction generation process, according to another exemplary embodiment. The instruction generation process may be executed by a fingerprint identification module, for example fingerprint identification module 160.

With reference to flow chart 300, at least two frames of fingerprint images of the same fingerprint may be acquired (301).

According to some embodiments, the fingerprint identification module may acquire the frames of fingerprint images at predetermined time intervals.

According to some embodiments, the fingerprint identification module further includes a contact sensing device, where the contact sensing device may detect whether a finger of a user contacts the fingerprint identification module. When the contact sensing device detects the finger of the user contacting the fingerprint identification module, the fingerprint identification module may be allowed to acquire the fingerprint frames by capturing images of the fingerprints. The images may be captured according to the predetermined time interval. When the contact sensing device stops detecting the finger of the user contacting the fingerprint identification module, the fingerprint identification module may stop acquiring the fingerprint frames.

For the same fingerprint, the fingerprint identification module may acquire a sequence of fingerprint images, the sequence of fingerprint images may include multiple frames of fingerprint images which are sequentially arranged. If the finger of the user translates, rotates, or otherwise moves on the fingerprint identification module, the fingerprint images in the sequence of fingerprint images may reflect such a movement.

With reference to flow chart 300, n characteristic areas in the ith frame of fingerprint image may be acquired, where i is a positive integer and n is also a positive integer (302).

The sequence of fingerprint images may include the multiple frames of fingerprint images which are sequentially arranged. According to some embodiments, the fingerprint identification module may analyze a position change through two adjacent frames of fingerprint images. First, the fingerprint identification module acquires n characteristic areas in the ith frame of fingerprint images. Each characteristic area may be an area including x*y pixels, where values of x and y depend on requirements on a calculation capability and identification accuracy of the fingerprint identification module. Generally, each characteristic area may have the same size, but may also have different sizes.

With respect to whether the characteristic areas are predetermined or dynamically selected, any one of the following two implementation manners may be adopted.

For example n characteristic areas in the ith frame of fingerprint image may be acquired according to n predetermined area positions.

In this implementation, the n area positions may be predetermined, and when the finger of the user is placed on the fingerprint identification area, local images of the fingerprint image in n areas are acquired as the n characteristic areas.

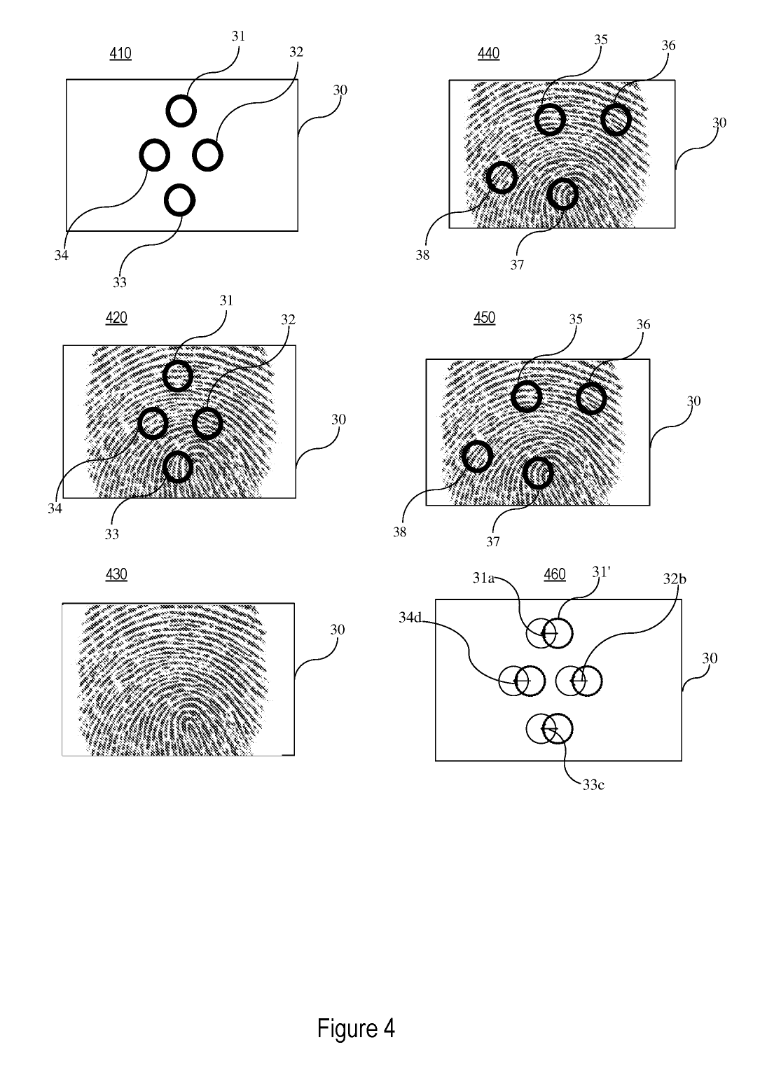

FIG. 4 illustrates various exemplary frames of fingerprint images as well as exemplary characteristic area maps for identifying an image attribute detected from the frames. For example, exemplary characteristic area map 410 illustrates four round areas 31, 32, 33, and 34 that may be representative of four predetermined characteristic areas corresponding to fingerprint identification area 30. As shown in exemplary first fingerprint frame 420 illustrated in FIG. 4 that includes a first fingerprint image, when the finger of the user is placed in the fingerprint identification area 30, the 4 characteristic areas in the round areas 31, 32, 33, and 34are acquired from the first fingerprint image included in the first fingerprint frame 420, and the fingerprint identification module stores the obtained four characteristic areas in a memory of the fingerprint identification module.

In another example, n characteristic areas may be acquired from the ith frame of a fingerprint image according to a predetermined condition, wherein the predetermined condition comprises at least one of the following: an image quality definition is higher than a first threshold value, an image contrast is higher than a second threshold value, a local image characteristic is consistent with a predetermined characteristic, or the current area is a matched area relative to a reference area in the previous frame of the fingerprint image.

In this implementation, the n area positions are not predetermined, and the n characteristic areas are dynamically selected according to the ith frame of fingerprint image obtained by placing the finger of the user in the fingerprint identification area.

As shown in exemplary fingerprint frame 430 illustrated in FIG. 4 that includes the first fingerprint image, the fingerprint identification module has acquired the first fingerprint image captured in the fingerprint identification area 30. Image characteristic information that describes one or more attributes of the first fingerprint image from fingerprint frame 430 may be compared with a first threshold value For example, areas on the first fingerprint image determined to have the top 4 image quality definitions higher than the first threshold value may be selected to be representative of the 4 characteristic areas, where the first threshold value may be set according to an identification requirement. It follows that the round areas 35, 36, 37, and 38 illustrated in exemplary fingerprint frame 440 that includes the first fingerprint image may be representative of the 4 acquired characteristic areas, and the 4 acquired characteristic areas are stored in the fingerprint identification module.

Similarly, the fingerprint identification module may also select the characteristic areas according to at least one of following: the image contrast is higher than the second threshold value, the local image characteristic is consistent with the predetermined characteristic and the current area is the matched area relative to the reference area in the previous frame of fingerprint image.

With reference to flow chart 300, the (i+1)th frame of the fingerprint images may be analyzed and searched for matched areas that match up with the n characteristic areas, respectively (303).

For example, for a given characteristic area, if the characteristic area is determined to have moved in the (i+1)th frame of the fingerprint images, the matched area of the characteristic area may be found in the (i+1)th frame of the fingerprint images by virtue of a motion object detection technology.

A similarity between each characteristic area and the corresponding matched area detected from subsequent fingerprint frames may be represented by, for example, a parameter such as a Hadamard Absolute Difference (HAD), a Sum of Absolute Difference (SAD) and a Sum of Absolute Transformed Difference (SATD). That is, for each characteristic area, the matched area may be found in the (i+1)th frame of fingerprint images.

For example, as shown in exemplary second fingerprint frame 450 corresponding to a second fingerprint image of the user's finger in FIG. 4, when the finger of the user moves in the fingerprint identification area 30, the second fingerprint frame 450 is recorded in the memory of the fingerprint identification module. The second fingerprint frame 450 may be analyzed to identify attributes of the second fingerprint image. In particular, the second fingerprint frame 450 may be analyzed to determine characteristic areas that can be correlated, or matched, with the four selected characteristic areas in the first fingerprint frame 420. The four round areas shown in second fingerprint frame 450 may be determined to represent the characteristic areas corresponding to the second fingerprint frame 450, and then information describing the determined characteristic areas of the second fingerprint frame 450 may be stored in the memory of the fingerprint identification module. The determined characteristic areas of the second fingerprint frame 450 may be referred to as the matched areas, whereas the determined characteristic areas corresponding to the first fingerprint frame 420 may be referred to as the characteristic areas.

With reference to flow chart 300, for each characteristic area corresponding to the first fingerprint frame 420, a difference in location and/or direction between the characteristic areas and the corresponding matched areas may be determined (304). For example, a motion vector of the characteristic area may be calculated according to the characteristic areas and the corresponding matched areas.

The fingerprint identification module may calculate the motion vectors between the characteristic areas and the corresponding matched areas as determined from the two fingerprint frames including the two fingerprint images, first fingerprint frame 420 and second fingerprint frame 450, respectively. In particular, the fingerprint identification module may calculate the motion vectors between the characteristic areas and the corresponding matched areas according to position information of the characteristic areas and the corresponding matched areas, where the motion vectors may include a motion direction and a motion distance between the characteristic areas and the corresponding matched areas, which represents a movement of the user's finger on the fingerprint identification area 30.

As shown in exemplary characteristic area map 460 illustrated in FIG. 4, a dotted round area 31′ represents a position of the characteristic area in the first fingerprint frame 420 that includes the first fingerprint image, and a solid round area 32′ represents a position of the matched area in the second fingerprint frame 450 that includes the second fingerprint image that is matched with the characteristic area of the first fingerprint frame 420. The fingerprint identification module may calculate the motion vector of the characteristic area 31 according to the characteristic area and the corresponding matched area. The center points of two round areas may be selected as starting and ending points, where vector 31a is the motion vector of the characteristic area 31, the vector 32b is the motion vector of the characteristic area 32, the vector 33c is the motion vector of the characteristic area 33 and the vector 34d is the motion vector of the characteristic area 34.

With reference to flow chart 300, the motion vectors of the n characteristic areas may be determined as position change information of the fingerprint as the movement of the fingerprint is detected from each subsequent fingerprint frame (305).

As shown by characteristic area map 460, the fingerprint identification module calculates the motion vectors of the characteristic areas 31, 32, 33, and 34 determined from the first fingerprint frame 420, and determines the four motion vectors as the position change information of the fingerprint as it moves.

The motion vector 31a indicates that the characteristic area 31 translates leftwards by 2 units, the motion vector 32b indicates that the characteristic area 32 translates leftwards by 2 units, the motion vector 33c indicates that the characteristic area 33 translates leftwards by 2 units and the motion vector 34d indicates that the characteristic area 34 translates leftwards by 2 units.

With reference to flow chart 300, an operational instruction (e.g., a translation instruction) according to the n motion vectors may be generated when motion directions of the n motion vectors are determined to be the same (306).

As shown by characteristic area map 460, the directions of the 4 motion vectors are the same, are directed leftward, and the motion distances are all 2 units. Based at least on these factors, the fingerprint identification module may generate the translation instruction. The translation instruction contains a translation direction and a translation distance, e.g., information indicating that the motion direction is leftward and the motion distance is 2 units.

According to some embodiments, the fingerprint identification module may transmit the generated translation instruction to a Central Processing Unit (CPU) (e.g., processor 120 of mobile terminal 100), and the CPU may control the operation object displayed on the mobile terminal to translate leftwards by 2 units according to the translation instruction.

With reference to flow chart 300, when n is more than or equal to 2 and the motion directions of the n motion vectors are different, a rotation direction and a rotation angle may be determined according to the n motion vectors (307).

According to some embodiments, when the directions of the n motion vectors are inconsistent, the rotation direction and the rotation angle may be determined to generate another operational instruction according to the motion vectors.

According to some embodiments, the process described at (307) may comprise two or more sub-processes as described by flow chart 500 that describes exemplary logic that may be implemented according to the process described at (307).

For instance, the process described at (307) may include determining a rotating center point of one or more characteristic areas according to a perpendicular bisector corresponding to each of the n motion vectors (307a).

The fingerprint identification module may determine the rotating center point according to the perpendicular bisector corresponding to each calculated motion vector.

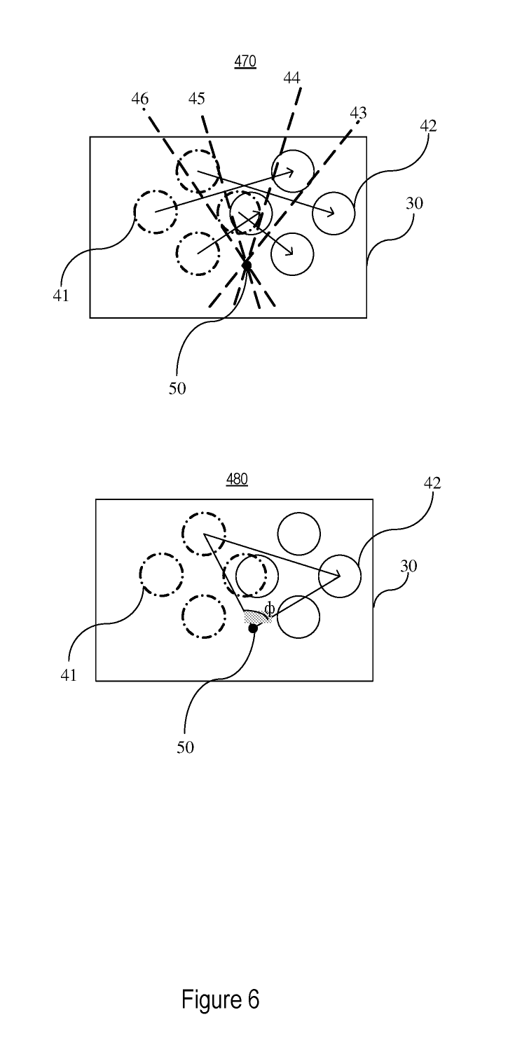

For example, as shown in exemplary characteristic area map 470 illustrated in FIG. 6, a dotted round area 41 represents positions of four characteristic areas in the ith frame of a fingerprint image, a solid round area 42 represents a position of the matched areas matched with the characteristic areas in the (i+1)th frame of fingerprint image, dotted lines 43, 44, 45, and 46 represent the perpendicular bisectors of four motion vectors, and a rotating center point 50 is an intersection of the perpendicular bisectors of the 4 motion vectors, i.e. the rotating center point.

The process described at (307) may further include determining a rotation direction and a rotation angle for rotating an operation object according to the directions of the n motion vectors and the rotating center point (307b).

The fingerprint identification module may determine the rotation direction according to the direction of any motion vector relative to the rotating center point 50. The fingerprint identification module may determine the rotation angle according to determined included angles between connecting lines of a starting point and ending point of any motion vector crossing through with the rotating center point 50.

As shown in exemplary characteristic area map 480 illustrated in FIG. 6, the fingerprint identification module may determine that the rotation direction is clockwise and that the rotation angle φ is 90 degrees based on the information provided from the motion vectors and the relationship to the rotating center point 50.

With reference to flow chart 300, a rotation instruction may be generated according to the rotation direction and the rotation angle (308).

The fingerprint identification module may generate the rotation instruction, or another operational instruction (e.g., parallel movement instruction based on two touch points moving in parallel, sliding instruction based on a touch point moving across a touch screen, sliding acceleration instruction based on an acceleration of a moving touch point across a touch screen), according to the calculated rotation direction and rotation angle, where the rotation instruction includes the rotation direction and the rotation angle.

According to some embodiments, the fingerprint identification module may transmit the generated rotation instruction to the connected CPU, and the CPU may control the operation object to rotate clockwise by 90 degrees according to the rotation instruction.

In view of the above, according to the instruction generation process described by flow chart 300, different position information corresponding to the tracking of movement of a user's finger (or other detectable object) as captured by fingerprint images included in fingerprint frames, is analyzed to obtain the corresponding position change information to form the corresponding operational instruction, where and the operational instruction may be configured to implement a translation control or a rotation control over the operation object, so that the fingerprint identification module may be repurposed to achieve additional features on the mobile terminal. It follows that the fingerprint identification module may be utilized to generate the operational instruction for controlling a translation operation, a rotation operation, or some other movement-based operational control for controlling movement of the operation object on the mobile terminal.

According to the disclosed instruction generation process, the translation operation and rotation operation applied to control the operation object may further be distinguished according to whether the motion directions of the multiple motion vectors are the same or different, and the translation instruction or the rotation instruction may be calculated by virtue of the motion vectors formed by the n characteristic areas and the matched areas, so that identifying the type of operational instruction to implement based on the user's finger movement as detected from the captured fingerprint images may be achieved.

When the finger of the user moves, for example, in the identification area 30 of the fingerprint identification module, the fingerprint identification module may acquire six fingerprint frames including fingerprint images, acquire four characteristic areas in the first fingerprint frame 420 that includes the first fingerprint image, analyze the second fingerprint frame 450 that includes the fingerprint image that captures a movement of the user's finger and identify four matched areas matched with the characteristic areas respectively, calculate motion vectors for the four characteristic areas based on a difference of the characteristic areas and the matched areas, determine the position change information of the fingerprint according to the motion vectors, and generate the corresponding operational instruction. After the operational instruction is generated, the fingerprint identification module may store the four matched areas identified from the second fingerprint frame 450 as a current four characteristic areas, proceed to analyze a third fingerprint frame that includes a fingerprint image that captures a movement of the user's finger and identify four matched areas matched with the current characteristic areas respectively, and executes process (304) to process (308) after the matched areas are identified. Similarly, the fingerprint identification module may analyze the fourth, fifth and sixth fingerprint frames of fingerprint images for four corresponding matched areas respectively, and executes process (304) to process (308). It follows that the disclosed instruction generation process may be an iterative process that runs on subsequent fingerprint frames. Different position information of the same fingerprint in the fingerprint images may be analyzed to obtain the corresponding position change information to form the corresponding operational instruction, so that the effect of controlling the operation object on the mobile terminal may be achieved.

In another schematic example, due to movement of the finger, the originally selected characteristic areas may move off the identification area of the fingerprint identification module, which may cause a condition where the position change information of the fingerprint cannot be determined according to the motion vectors of the characteristic areas due to the characteristic areas no longer being detectable on the identification area. To address this situation, according to some embodiments the fingerprint identification module may be configured such that after the ith frame of fingerprint image is acquired, when i is an odd number, n characteristic areas may be selected for the ith frame of fingerprint image, the (i+1)th frame of fingerprint image may be analyzed to identify matched areas that match with the characteristic areas in the ith frame, the motion vectors of the characteristic areas may be calculated according to the characteristic areas and the matched areas, and the position change of the fingerprint may be determined according to the motion vectors, thereby generating the resulting operational instruction to implement control over the operation object.

For example, after acquiring six fingerprint frames including fingerprint images of the same fingerprint, the fingerprint identification module may be configured to analyze and select four characteristic areas from a first fingerprint frame and store the four characteristic areas. The fingerprint identification module may further be configured to analyze and select a second fingerprint frame for the matched areas matched with the characteristic areas, execute process (304) to process (308) after the matched areas are found, reselect characteristic areas from a third fingerprint frame after process (304) to process (308) are finished, search a fourth fingerprint frame for the matched areas, execute process (303) to process (308), and implement the same operation on the other fingerprint frames until the position change information of the fingerprint is determined. The characteristic areas and the matched areas may be continuously selected from the fingerprint images, so that the operational instruction may still be accurately generated to implement control over the operation object even when a certain fingerprint is not in the identification area is achieved.

It is important to note that the number n of the characteristic areas required by different operating instructions is different, the number n of the characteristic area required by the translation instruction is at least 1, and the number n of the characteristic areas required by the rotation instruction is at least 2.

It is important to note that, according to some embodiments the fingerprint identification module may acquires the fingerprint images and transmit the fingerprint images to a CPU or other processor of a mobile terminal in communication with the fingerprint identification module such that the CPU or other processor executes some or all of the processes described in flow chart 300. In particular, the CPU or other processor of the mobile terminal may be responsible for implementing process (302) to process (308).

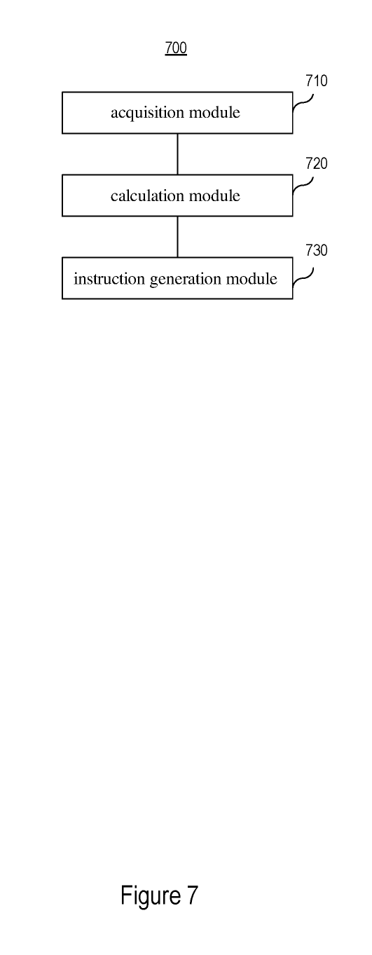

FIG. 7 is a diagram showing an exemplary architecture of a device 700 configured to implement an instruction generation process as described herein. The device 700 may include one or more components of the mobile terminal described herein for implementing an instruction generating process. For example, the device 700 may include an acquisition module 710, a calculation module 720, and an instruction generation module 730. Each of the modules may be a combination of software, hardware, and/or circuitry for implementing corresponding processes.

The acquisition module 710 may be configured to acquire at least two frames of fingerprint images of the same fingerprint.

The calculation module 720 may be configured to calculate position change information of the fingerprint according to the at least two frames of fingerprint images.

The instruction generation module 730 may be configured to generate an operational instruction according to the position change information, wherein the operational instruction may include a translation instruction and/or a rotation instruction.

In view of the above, different position information of the same fingerprint captured in the fingerprint images may be analyzed to obtain the corresponding position change information to generate the corresponding operational instruction. It follows that the fingerprint identification module may be configured to detect a user's finger movement and correlate the movement to an operational instruction (e.g., identifying a translation operation or a rotation operation) for controlling a movement of an operation object in the mobile terminal.

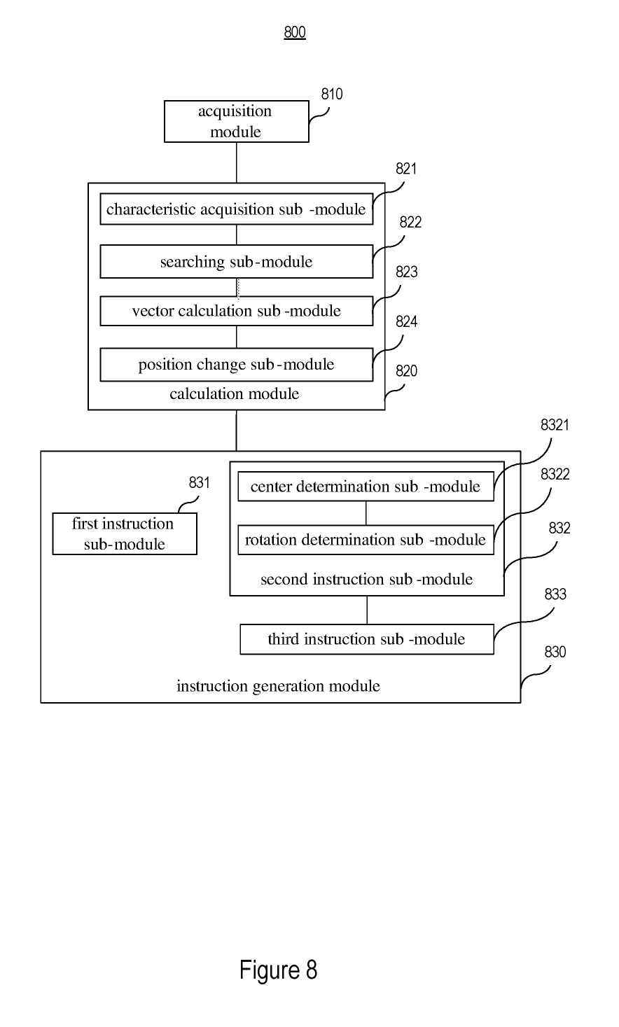

FIG. 8 is a diagram showing an exemplary architecture of a device 800 configured to implement an instruction generation process as described herein. The device 800 may include one or more components of the mobile terminal described herein for implementing an instruction generating process. For example, the device 800 may include an acquisition module 810, a calculation module 820, and an instruction generation module 830. Each of the modules may be a combination of software, hardware, and/or circuitry for implementing corresponding processes.

The acquisition module 810 may be configured to acquire at least two frames of fingerprint images of the same fingerprint.

The calculation module 820 may be configured to calculate position change information of the fingerprint according to the at least two frames of fingerprint images.

The instruction generation module 830 may be configured to generate an operational instruction according to the position change information, wherein the operational instruction may include a translation instruction and/or a rotation instruction.

The calculation module 820 may include a characteristic acquisition sub-module 821, a searching sub-module 822, a vector calculation sub-module 823, and a position change sub-module 824.

The characteristic acquisition sub-module 821 may be configured to acquire n characteristic areas in the ith frame of the fingerprint images, i being an integer and n being a positive integer.

The searching sub-module 822 may be configured to search, in the (i+1)th frame of fingerprint image, for matched areas matched with the n characteristic areas respectively.

The vector calculation sub-module 823 may be configured to, for each characteristic area, calculate a motion vector of the characteristic area according to the characteristic area and the corresponding matched area.

The position change sub-module 824 may be configured to determine the motion vectors of the n characteristic areas as the position change information of the fingerprint.

The characteristic acquisition sub-module 821 may be configured to acquire the n characteristic areas in the ith frame of fingerprint image according to n predetermined area positions. According to some embodiments, the characteristic acquisition sub-module 821 may be configured to acquire the n characteristic areas from the ith frame of fingerprint image according to a predetermined condition, where the predetermined condition may include at least one of the following: an image quality definition is higher than a first threshold value, an image contrast is higher than a second threshold value and a local image characteristic is consistent with a predetermined characteristic.

The instruction generation module 830 may include a first instruction sub-module 831, a second instruction sub-module 832, and a third instruction sub-module 833.

The first instruction sub-module 831 may be configured to generate the translation instruction according to the n motion vectors when motion directions of the n motion vectors are the same.

The second instruction sub-module 832 may be configured to, when n is more than or equal to 2 and the motion directions of the n motion vectors are different, determine a rotation direction and a rotation angle according to the n motion vectors.

The third instruction sub-module 833 may be configured to generate the rotation instruction according to the rotation direction and the rotation angle.

The second instruction sub-module 832 may include a center determination sub-module 8321 and a rotation determination sub-module 8322.

The center determination sub-module 8321 may be configured to determine a rotating center point according to a perpendicular bisector corresponding to each of the n motion vectors.

A rotation determination sub-module 8322 may be configured to determine the rotation direction and the rotation angle according to the directions of the n motion vectors and the rotating center point.

In view of the above, different position information of the same fingerprint in the fingerprint images may be analyzed to obtain the corresponding position change information to generate the corresponding operational instruction, and the operational instruction may be configured to implement a translation control or a rotation control over an operation object. It follows that the fingerprint identification module may be configured to detect a user's finger movement and correlate the movement to an operational instruction (e.g., identifying a translation operation or a rotation operation) for controlling a movement of an operation object in the mobile terminal.

According the translation operation and rotation operation of the user may be further distinguished according to whether the motion directions of the multiple motion vectors are the same or different, and the translation instruction or the rotation instruction is calculated by virtue of the motion vectors formed by the n characteristic areas and the matched areas, so that the effect of identifying a type of the operation of the user and further generating the corresponding operating instruction by virtue of the fingerprint identification module is achieved.

The present disclosure further provides an instruction generation device, which includes: a processor; and a memory configured to store executable instructions of the processor, wherein the processor may be configured to: acquire at least two frames of fingerprint images of the same fingerprint; calculate position change information of the fingerprint according to the at least two frames of fingerprint images; and generate an operating instruction according to the position change information, wherein the operating instruction comprises a translation instruction and/or a rotation instruction.

According to some embodiments, calculating position change information of the fingerprint according to the at least two frames of fingerprint images includes: acquiring n characteristic areas in the ith frame of fingerprint image, i being an integer and n being a positive integer; searching, in the (i+1)th frame of fingerprint image, for matched areas matched with the n characteristic areas respectively; for each characteristic area, calculating a motion vector of the characteristic area according to the characteristic area and the corresponding matched area; and determining the motion vectors of the n characteristic areas as the position change information of the fingerprint.

According to some embodiments, acquiring n characteristic areas in the ith frame of fingerprint image includes: acquiring the n characteristic areas in the ith frame of fingerprint image according to n predetermined area positions; or acquiring the n characteristic areas from the ith frame of fingerprint image according to a predetermined condition, wherein the predetermined condition comprises at least one of the following: a definition is higher than a first threshold value, a contrast is higher than a second threshold value and a local characteristic is consistent with a predetermined characteristic.

According to some embodiments, generating an operating instruction according to the position change information includes: generating the translation instruction according to the n motion vectors when motion directions of the n motion vectors are the same.

According to some embodiments, generating the operating instruction according to the position change information includes: when n is more than or equal to 2 and the motion directions of the n motion vectors are different, determining a rotation direction and a rotation angle according to the n motion vectors; and generating the rotation instruction according to the rotation direction and the rotation angle.

According to some embodiments, determining a rotation direction and a rotation angle according to the n motion vectors includes: determining a rotating center point according to a perpendicular bisector corresponding to each of the n motion vectors; and determining the rotation direction and the rotation angle according to the directions of the n motion vectors and the rotating center point.

In view of the above, according to the instruction generation device provided by the embodiment, different position information of the same fingerprint in the fingerprint images is analyzed to obtain the corresponding position change information to form the corresponding operating instruction, and the operating instruction may be configured to implement a translation control or a rotation control over an operation object, so that the problem that a fingerprint identification module may further be utilized for identifying a translation operation or a rotation operation of a user to further control the operation object in electronic equipment by utilizing the fingerprint identification module as a human-computer interaction component is achieved.

According to the instruction generation device provided by the embodiment, the translation operation and rotation operation of the user are further distinguished according to whether the motion directions of the multiple motion vectors are the same or different, and the translation instruction or the rotation instruction is calculated by virtue of the motion vectors formed by the n characteristic areas and the matched areas, so that the effect of identifying a type of the operation of the user and further generating the corresponding operating instruction by virtue of the fingerprint identification module is achieved.

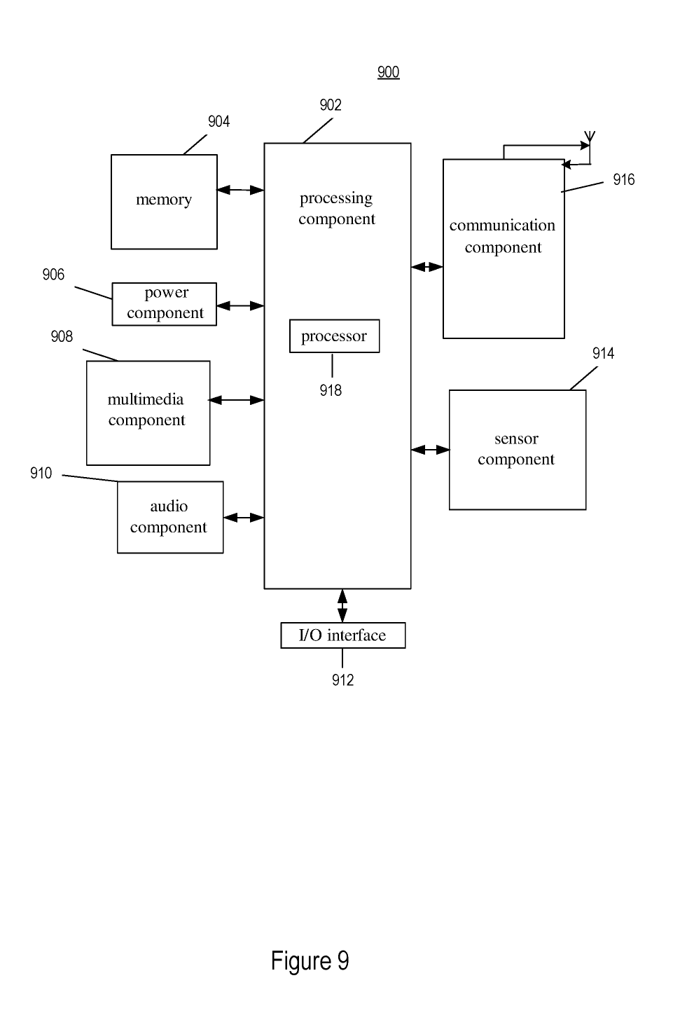

FIG. 9 is a block diagram of a device 900 configurable to implement an instruction generation process or other feature described herein, according to an exemplary embodiment. For example, the device 900 may correspond to the mobile terminal described herein for implementing features of the instruction generation process. The device may also be a mobile phone, a computer, a digital broadcast terminal, a messaging device, a gaming console, a tablet, a medical device, exercise equipment, a personal digital assistant or the like, similarly configured to implement features of the instruction generation process.

Referring to FIG. 9, the device 900 may include one or more of the following components: a processing component 902, a memory 904, a power component 906, a multimedia component 908, an audio component 910, an Input/Output (I/O) interface 912, a sensor component 914, and a communication component 916.

The processing component 902 may control overall operations of the device 900, such as the operations associated with display, telephone calls, data communications, camera operations, and recording operations. The processing component 902 may include one or more processors 918 to execute instructions to perform all or part of the steps in the abovementioned methods. Moreover, the processing component 902 may include one or more modules which facilitate interaction between the processing component 902 and the other components. For instance, the processing component 902 may include a multimedia module to facilitate interaction between the multimedia component 908 and the processing component 902.

The memory 904 may be configured to store various types of data to support the operation of the device 900. Examples of such data include instructions for any applications or methods operated on the device 900, contact data, phonebook data, messages, pictures, video, etc. The memory 904 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The power component 906 provides power for various components of the device 900. The power component 906 may include a power management system, one or more power supplies, and other components associated with the generation, management and distribution of power for the device 900.

The multimedia component 908 includes a screen providing an output interface between the device 600 and the user. In some embodiments, the screen may include a Liquid Crystal Display (LCD) and a Touch Panel (TP). If the screen includes the TP, the screen may be implemented as a touch screen to receive an input signal from the user. The TP includes one or more touch sensors to sense touches, swipes and gestures on the TP. The touch sensors may sense a boundary of a touch or swipe action, and also sense a duration and pressure associated with the touch or swipe action. In some embodiments, the multimedia component 908 includes a front camera and/or a rear camera. The front camera and/or the rear camera may receive external multimedia data when the device 900 is in an operation mode, such as a photographing mode or a video mode. Each of the front camera and the rear camera may be a fixed optical lens system or have focusing and optical zooming capabilities.

The audio component 910 is configured to output and/or input an audio signal. For example, the audio component 910 includes a microphone (MIC), and the MIC is configured to receive an external audio signal when the device 900 is in the operation mode, such as a call mode, a recording mode and a voice recognition mode. The received audio signal may be further stored in the memory 904 or sent through the communication component 916. In some embodiments, the audio component 910 further includes a speaker configured to output the audio signal.

The I/O interface 912 provides an interface between the processing component 902 and a peripheral interface module, and the peripheral interface module may be a keyboard, a click wheel, a button and the like. The button may include, for example: a home button, a volume button, a starting button and a locking button.

The sensor component 914 includes one or more sensors configured to provide status assessment in various aspects for the device 900. For instance, the sensor component 914 may detect an on/off status of the device 900 and relative positioning of components, such as a display and small keyboard of the device 900, and the sensor component 914 may further detect a change in a position of the device 900 or a component of the device 900, presence or absence of contact between the user and the device 900, orientation or acceleration/deceleration of the device 900 and a change in temperature of the device 900. The sensor component 914 may include a proximity sensor configured to detect presence of an object nearby without any physical contact. The sensor component 914 may also include a light sensor, such as a Complementary Metal Oxide Semiconductor (CMOS) or Charge Coupled Device (CCD) image sensor, configured for use in an imaging application. In some embodiments, the sensor component 914 may also include an acceleration sensor, a gyroscope sensor, a magnetic sensor, a pressure sensor or a temperature sensor.

The communication component 916 is configured to facilitate wired or wireless communication between the device 900 and another device. The device 900 may access a communication-standard-based wireless network, such as a Wireless Fidelity (WiFi) network, a 2nd-Generation (2G) or 3rd-Generation (3G) network or a combination thereof. In an exemplary embodiment, the communication component 916 receives a broadcast signal or broadcast associated information from an external broadcast management system through a broadcast channel. In an exemplary embodiment, the communication component 916 further includes a Near Field Communication (NFC) module to facilitate short-range communication. For example, the NFC module may be implemented on the basis of a Radio Frequency Identification (RFID) technology, an Infrared Data Association (IrDA) technology, an Ultra-WideBand (UWB) technology, a BlueTooth (BT) technology and another technology.

In the exemplary embodiment, the device 900 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned methods.

In the exemplary embodiment, there is also provided a non-transitory computer-readable storage medium including an instruction, such as the memory 904 including an instruction, and the instruction may be executed by the processor 918 of the device 900 to implement the abovementioned features. For example, the non-transitory computer-readable storage medium may be a ROM, a Radom Access Memory (RAM), a Compact Disc Read-Only Memory (CD-ROM), a magnetic tape, a floppy disc, an optical data storage device and the like.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that various modifications and changes may be made to the features described herein without departing from the scope of this disclosure.

### INDUSTRIAL APPLICABILITY

According to the instruction generation method provided by the present disclosure, different position information of the same fingerprint in the fingerprint images is analysed to obtain the corresponding position change information to form the corresponding operating instruction, and the operating instruction may be configured to implement a translation control or a rotation control over the operation object, so that the problem that the fingerprint identification module may be utilized for identifying a translation operation or a rotation operation of a user to further control the operation object in the electronic equipment by utilizing the fingerprint identification module as a human-computer interaction component is achieved.

What is claimed is:

1. A method for generating an operational instruction, the method comprising:
acquiring a first image frame, the first image frame including an image of a first fingerprint;
acquiring a second image frame, the second image frame including an image of a second fingerprint;
calculating position change information of the first fingerprint and the second fingerprint based on a difference between the first image frame and the second image frame;
controlling a display of an object on a display screen; and
generating an operational instruction for controlling a movement of the object on the display screen according to the position change information.

2. The method of claim 1, wherein calculating the position change information comprises:
acquiring a plurality of image frames, each image frame including an image of a fingerprint;
determining n characteristic areas in an i^{th} image frame from the plurality of image frames, i being an integer and n being an integer, wherein each of the n characteristic areas identifies a detected attribute included on the corresponding ith image frame;
analyzing a (i+1)^{th} image frame from the plurality of image frames;
determining n matched areas in the i+1)^{th} image frame that matches with the n characteristic areas of the i^{th} image frame, respectively, based on the analysis;
for each characteristic area, calculating a motion vector of the characteristic area based on the characteristic area and the corresponding matched area; and
determining the motion vectors of the n characteristic areas as the position change information of the fingerprint across the i^{th} image frame and the (i+1)^{th} image frame.

3. The method of claim 2, wherein acquiring n characteristic areas in the i^{th} image frame comprises at least one of:
acquiring the n characteristic areas in the i^{th} frame from the plurality of image frames that correspond to n predetermined area positions; or acquiring the n characteristic areas from the i^{th} frame of fingerprint image according to a predetermined condition, wherein the predetermined condition includes at least one of: an image quality definition being higher than a first threshold value, an image contrast being higher than a second threshold value, a local image characteristic being consistent with a predetermined characteristic, or the current area being a matched area relative to a reference area in a previous image frame.

4. The method of claim 2, wherein generating the operational instruction according to the position change information comprises:
generating the translation instruction based on n motion vectors when motion directions of the n motion vectors are the same.

5. The method of claim 2, wherein generating the operational instruction according to the position change information comprises:
when n is more than or equal to 2 and the motion directions of n motion vectors are different, determining a rotation direction and a rotation angle according to the n motion vectors; and
generating the rotation instruction based on the rotation direction and the rotation angle.

6. The method of claim 5, wherein determining the rotation direction and the rotation angle according to the n motion vectors comprises:
determining a rotating center point according to a perpendicular bisector corresponding to each of the n motion vectors; and
determining the rotation direction and the rotation angle according to the directions of the n motion vectors and the rotating center point.

7. The method of claim 1, wherein the movement includes at least one of a translational movement or a rotational movement.

8. An instruction generation device, comprising:
a processor; and
a memory configured to store processor executable instructions,
wherein the processor is configured to execute the instructions to:
acquire a first image frame, the first image frame including an image of a first fingerprint;
acquire a second image frame, the second image frame including an image of a second fingerprint;
calculate position change information of the first fingerprint and the second fingerprint based on a difference between the first image frame and the second image frame
control a display of an object on a display screen; and
generate an operational instruction for controlling a movement of the object on the display screen according to the position change information.

9. The instruction generation device of claim 8, wherein the processor is configured to execute the instructions to calculate the position change information by:
acquiring a plurality of image frames, each image frame including an image of a fingerprint;
determining n characteristic areas in an i^{th} frame from the plurality of image frames, i being an integer and n being an integer, wherein each of the n characteristic areas identifies a detected attribute included on the corresponding i^{th} image frame;
analyzing a (i+1)^{th} image frame from the plurality of image frames;
determining n matched areas in the (i+1)^{th} frame that matches with the n characteristic areas of the i^{th} image frame, respectively, based on the analysis;
for each characteristic area, calculating a motion vector of the characteristic area based on the characteristic area and the corresponding matched area; and
determining the motion vectors of the n characteristic areas as the position change information of the fingerprint across the i^{th} image frame and the (i+1)^{th} image frame.

10. The instruction generation device of claim 9, wherein the processor is configured to execute the instructions to acquire the n characteristic areas in the i^{th} image frame by at least one of:
acquiring the n characteristic areas in the i^{th} frame from the plurality of image frames that correspond to n predetermined area positions; or
acquiring the n characteristic areas from the i^{th} frame of fingerprint image according to a predetermined condition, wherein the predetermined condition includes at least one of: an image quality definition being higher than a first threshold value, an image contrast being higher than a second threshold value, a local image characteristic being consistent with a predetermined characteristic, or the current area being a matched area relative to a reference area in a previous image frame.

11. The instruction generation device of claim 9, wherein the processor is configured to execute the instructions to generate the operational instruction according to the position change information by:
generating the translation instruction based on the n motion vectors when motion directions of the n motion vectors are the same.

12. The instruction generation device of claim 9, wherein the step the processor is configured to execute the instructions to generate the operational instruction according to the position change information by:
when n is more than or equal to 2 and the motion directions of n motion vectors are different, determining a rotation direction and a rotation angle according to the n motion vectors; and
generating the rotation instruction based on the rotation direction and the rotation angle.

13. The instruction generation device of claim 12, wherein the processor is configured to execute the instructions to determine the rotation direction and the rotation angle according to the n motion vectors by:
determining a rotating center point according to a perpendicular bisector corresponding to each of the n motion vectors; and
determining the rotation direction and the rotation angle according to the directions of the n motion vectors and the rotating center point.

14. A non-transitory computer-readable storage medium having stored therein instructions that, when executed by a processor of a mobile terminal, causes the mobile terminal to perform a method for generating an instruction, the method comprising:
acquiring a first image frame, the first image frame including an image of a first fingerprint;
acquiring a second image frame, the second image frame including an image of a second fingerprint;
calculating position change information of the first fingerprint and the second fingerprint based on a difference between the first image frame and the second image frame;
controlling a display of an object on a display screen of the mobile terminal; and
generating an operational instruction for controlling a movement of the object on the display screen according to the position change information.

15. The non-transitory computer-readable storage medium of claim 14, wherein calculating the position change information comprises:
acquiring a plurality of image frames, each image frame including an image of a fingerprint;
determining n characteristic areas in an i^{th} image frame from the plurality of image frames, i being an integer and n being an integer, wherein each of the n characteristic areas identifies a detected attribute included on the corresponding i^{th} image frame;
analyzing a (i+1)^{th} image frame from the plurality of image frames;
determining n matched areas in the (i+1)^{th} image frame that matches with the n characteristic areas of the i^{th} image frame, respectively, based on the analysis;
for each characteristic area, calculating a motion vector of the characteristic area based on the characteristic area and the corresponding matched area; and
determining the motion vectors of the n characteristic areas as the position change information of the fingerprint across the i^{th} image frame and the (i₊1)^{th} image frame.

16. The non-transitory computer-readable storage medium of claim 15, wherein acquiring n characteristic areas in the i^{th} image frame comprises at least one of:
acquiring the n characteristic areas in the i^{th} frame from the plurality of image frames that correspond to n predetermined area positions; or
acquiring the n characteristic areas from the i^{th} frame of fingerprint image according to a predetermined condition, wherein the predetermined condition includes at least one of: an image quality definition being higher than a first threshold value, an image contrast being higher than a second threshold value, a local image characteristic being consistent with a predetermined characteristic, or the current area being a matched area relative to a reference area in a previous image frame.

17. The non-transitory computer-readable storage medium of claim 15, wherein generating the operational instruction according to the position change information comprises:
generating the translation instruction based on the n motion vectors when motion directions of the n motion vectors are the same.

18. The non-transitory computer-readable storage medium of claim 15, wherein generating the operational instruction according to the position change information comprises:
when n is more than or equal to 2 and the motion directions of n motion vectors are different, determining a rotation direction and a rotation angle according to the n motion vectors; and
generating the rotation instruction based on the rotation direction and the rotation angle.

19. The non-transitory computer-readable storage medium of claim 18, wherein determining the rotation direction and the rotation angle according to the n motion vectors comprises:
determining a rotating center point according to a perpendicular bisector corresponding to each of the n motion vectors; and
determining the rotation direction and the rotation angle according to the directions of the n motion vectors and the rotating center point.

20. The non-transitory computer-readable storage medium of claim 14, wherein the movement includes at least one of a translational movement or a rotational movement
